(19) United States
(12) Patent Application Publication
(10) Pub. No.: US 2026/0291424 A1
(43) Pub. Date: Sep. 24, 2026

(54) INTELLIGENT CONTROLS FOR INDEPENDENTLY OPERABLE INVERTERS

(71) Applicant: Cummins Inc., Columbus, IN (US)

(72) Inventors: Jaroslaw Leonarski, Columbus, IN (US); Jennifer Kay Light-Holets, Greenwood, IN (US); Aaron William Beinborn, Greenwood, IN (US)

(21) Appl. No.: 19/473,047

(22) PCT Filed: Apr. 9, 2024
(86) PCT No.: PCT/US2024/023674

§ 371 Date: Oct. 6, 2025

Related U.S. Application Data
(60) Provisional application No. 63/466,567, filed on May 15, 2023.

(51) Int. Cl. H02P 29/68; H02P 27/06

(52) U.S. Cl. CPC H02P 29/68; H02P 27/06

(57) ABSTRACT

Methods of operating an electric machine having a plurality of independently operable inverters, and systems implementing the same, include: receiving a torque demand for the electric machine; receiving a torque demand for the electric machine; determining available inverters based on the plurality of independently operable inverters; selecting a subset number of inverters from the available inverters to operate based on an efficiency map of the electric machine and the torque command for the electric machine; and switching operation of at least one of the subset number of inverters with at least one of the available inverters that is not in the selected subset number of inverters based on one or more conditions.

### FIELD OF THE DISCLOSURE

The present disclosure relates generally to electric machines and more specifically to multiphase electric machines.

### BACKGROUND OF THE DISCLOSURE

Multiphase electric machines, such as permanent magnet motors, implement a plurality of coil windings that are wound around the teeth of the stator to form separate poles. The coil windings on certain poles are synchronized so as to provide the same magnetic polarity, forming a rotating magnetic field to cause rotation in the rotor that is coupled with the stator. Each of the coil windings is electrically coupled with a power inverter such that the inverter converts the DC power provided by a DC energy source to AC power to be used to control the polarity of the poles.

One of the problems regarding inverters is their tendency to exhibit a decrease in efficiency with rising temperature. In many cases high temperature in an inverter can deplete its life expectancy, performance, and/or cause physical damage to the system in which the inverter is implemented. Same may be applicable to electrical machines. As such, there is a need to monitor and control the temperature of inverters and electrical machines to reduce its average value and improve system performance and lifetime span.

### SUMMARY OF THE DISCLOSURE

Methods and systems are disclosed to prolong the useful life expectancy of the individually operable inverter components of an electric machine by prioritizing selected pair(s) or group(s) of inverters for use when less than the entire set of inverters is required for operation to meet the power demand. According to the present disclosure, a method of operating an electric machine having a plurality of independently operable inverters includes: receiving a torque demand, determining available inverters based on the plurality of independently operable inverters, and selecting, from the available inverters, which inverters to operate.

In one aspect of the disclosure, a method of operating an electric machine using a controller is disclosed. The method includes: receiving a torque demand for the electric machine, the electric machine comprising a plurality of independently operable inverters; determining available inverters based on the plurality of independently operable inverters; selecting, from the available inverters, a subset number of inverters to operate based on an efficiency map of the electric machine and the torque demand for the electric machine; and based on one or more conditions, switching operation of at least one of the subset number of inverters with at least one of the available inverters that is not in the subset number of inverters.

In some examples, the one or more conditions include one or more of: temperatures of the plurality of independently operable inverters, fault conditions of the plurality of independently operable inverters, physical locations of the plurality of independently operable inverters, or health of the plurality of independently operable inverters.

In some examples, the switching the operation of the at least one of the subset number of inverters includes: monitoring a temperature of the available inverters during operation; and responsive to detecting that a temperature of at least one of the subset number of inverters or a temperature of at least one of the available inverters that is not in the subset number of inverters is reaching or approaching a threshold temperature, switching the operation of the at least one of the subset number of inverters with the at least one of the available inverters that is not in the subset number of inverters. In some examples, the threshold temperature is defined by a temperature range (ΔT) centering on a predetermined average temperature.

In some examples, the determining the available inverters includes: determining health data of the plurality of independently operable inverters; detecting at least one fault in at least one of the plurality of independently operable inverters; and removing, based on the health data and the at least one fault, unavailable inverters from being selected.

In some examples, the method further includes: recording, by a memory unit of the controller, a number of times or a length of time that each of the plurality of independently operable inverters is used; and determining health data based on the number of times or the length of time that the each of the plurality of independently operable inverters is used. The health data is one of the one or more conditions. In some examples, the selecting of the subset number of inverters to operate includes: monitoring the temperature of the available inverters prior to the selecting; and selecting, from the available inverters, the subset number of inverters to operate based on the temperature that is monitored, wherein the subset number of inverters has a lowest temperature among the available inverters. In some examples, the threshold temperature is an upper threshold temperature or a lower threshold temperature, and the switching of the operation of the at least one of the subset number of inverters includes: detecting either (a) the temperature of the at least one of the subset number of inverters is reaching or approaching the upper threshold temperature, or (b) the temperature of the at least one of the available inverters that is not in the subset number of inverters is reaching or approaching the lower threshold temperature; and responsive to the detecting either (a) or (b), switching the operation of the at least one of the subset number of inverters with the at least one of the available inverters that is not in the subset number of inverters. In some examples, each of the available inverters has a unique threshold temperature range defined by the upper threshold temperature and the lower threshold temperature. In some examples, the method further includes: dynamically determining or changing, during the operation of the at least one of the subset number of inverters, the upper threshold temperature and the lower threshold temperature based on a change in the temperature of the at least one of the subset number of inverters.

In some examples, the subset number of inverters includes an even number of inverters, and the selecting the subset number of inverters to operate includes: grouping the available inverters into a plurality of available inverter groups, wherein each available inverter group includes at least two available inverters; and selecting at least one of the available inverter groups having a lowest temperature among the available inverter groups to operate. In some examples, each available inverter group includes a pair of available inverters coupled to machine winding sets positioned in 180 degrees of separation from each other in the electric machine. In some examples, the selecting of the at least one of the available inverter groups includes: selecting two or more available inverter pairs having a lowest total temperature or a lowest average temperature among the available inverter groups to operate. In some examples, the each available inverter group includes four available inverters coupled to machine winding sets positioned in 90 degrees of separation from each other in the electric machine.

In some examples, the method further includes: detecting a change in operating conditions of the electric machine indicative of a requirement to re-evaluate the subset number of inverters to be selected; and selecting, from the available inverters, a new subset number of inverters to operate based on the change in operating conditions of the electric machine.

In another aspect of the disclosure, a method of operating an electric machine using a controller is disclosed. The method includes: receiving a torque demand for the electric machine, the electric machine comprising a plurality of independently operable inverters; determining available inverters based on the plurality of independently operable inverters; selecting one or more inverter pairs of the available inverters to operate, wherein each inverter pair includes two of the available inverters coupled to machine winding sets positioned in 180 degrees of separation from each other in the electric machine; and switching operation of at least one of the selected inverter pairs with at least one other inverter pair of the available inverters, wherein the at least one other inverter pair is not among the selected inverter pairs of the available inverters.

In some examples, the switching the operation of the at least one of the selected inverter pairs comprises: performing a fault check of the selected inverter pairs of the available inverters to operate; determining, based on the fault check, that the at least one of the selected inverter pairs is faulty; and switching the operation of the at least one of the selected inverter pairs that is determined to be faulty with the at least one other inverter pair of the available inverters that is not among the selected inverter pairs of the available inverters. In some examples, the switching the operation of the at least one of the selected inverter pairs includes: determining, based on balancing an amount of coolant in the electric machine, the at least one other inverter pair of the available inverters for switching the operation; and switching the operation of the at least one of the selected inverter pairs with the at least one other inverter pair as determined.

In various aspects of the disclosure, a non-transitory computer-readable medium may store thereon instructions that, when executed by a processor, cause the processor to perform the method(s) as explained above.

In various aspects of the disclosure, an electric machine system may include: an electric machine comprising a plurality of independently operable inverters; a plurality of sets of windings, each coupled with one of the plurality of independently operable inverters; at least one sensor operatively coupled with the electric machine and configured to detect one or more conditions; a plurality of inverter controllers, each operatively coupled with one of the plurality of independently operable inverters; and a master controller operatively coupled with the plurality of inverter controllers and the at least one sensor. The master controller may include a processor and a memory unit storing thereon instructions that, when executed by the processor, causes the processor to perform the method(s) as explained above.

Additional features and advantages of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The detailed description of drawings particularly refers to the accompanying figures in which:

FIG. 1 is a schematic diagram of an electric machine system with a plurality of controllers controlling an electric machine as well as a master controller controlling the individual controllers according to embodiments disclosed herein;

FIG. 2 is a schematic diagram of a multiphase electric machine with independently operable inverter components according to embodiments disclosed herein;

FIG. 3 is a flow diagram of a process of operating the multiphase electric machine according to embodiments disclosed herein;

FIG. 4 is a flow diagram of a process of operating the multiphase electric machine according to embodiments disclosed herein;

FIG. 5 is a flow diagram of a process of operating the multiphase electric machine according to embodiments disclosed herein;

FIG. 6 is a flow diagram of a process of operating the multiphase electric machine according to embodiments disclosed herein;

FIG. 7 is a flow diagram of a process of operating the multiphase electric machine according to embodiments disclosed herein;

FIG. 8 is a flow diagram of a process of operating the multiphase electric machine according to embodiments disclosed herein;

FIG. 9 is a flow diagram of a process of operating the multiphase electric machine according to embodiments disclosed herein; and

FIG. 10 is a time vs temperature diagram of an example of inverter temperature fluctuation according to embodiments disclosed herein.

### DETAILED DESCRIPTION

In the following detailed description, reference is made to the accompanying drawings which form a part hereof, and in which is shown by way of illustration specific embodiments in which the present disclosure is practiced. These embodiments are described in sufficient detail to enable those skilled in the art to practice the present disclosure, and it is to be understood that other embodiments can be utilized and that structural changes can be made without departing from the scope of the present disclosure. Therefore, the following detailed description is not to be taken in a limiting sense, and the scope of the present disclosure is defined by the appended claims and their equivalents.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments. Furthermore, the described features, structures, or characteristics of the subject matter described herein may be combined in any suitable manner in one or more embodiments.

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings.

The terms “couples,” “coupled,” and variations thereof are used to include both arrangements wherein two or more components are in direct physical contact and arrangements wherein the two or more components are not in direct contact with each other (e.g., the components are “coupled” via at least a third component), but yet still cooperate or interact with each other. Furthermore, the terms “couples,” “coupled,” and variations thereof refer to any connection for machine parts known in the art, including, but not limited to, connections with bolts, screws, threads, magnets, electro-magnets, adhesives, friction grips, welds, snaps, clips, etc.

Throughout the present disclosure and in the claims, numeric terminology, such as first and second, is used in reference to various components or features. Such use is not intended to denote an ordering of the components or features. Rather, numeric terminology is used to assist the reader in identifying the component or features being referenced and should not be narrowly interpreted as providing a specific order of components or features.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example.

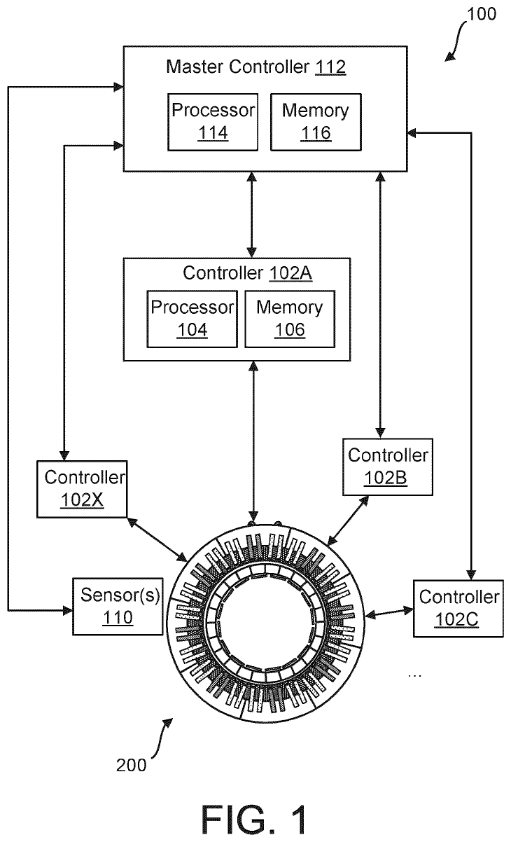

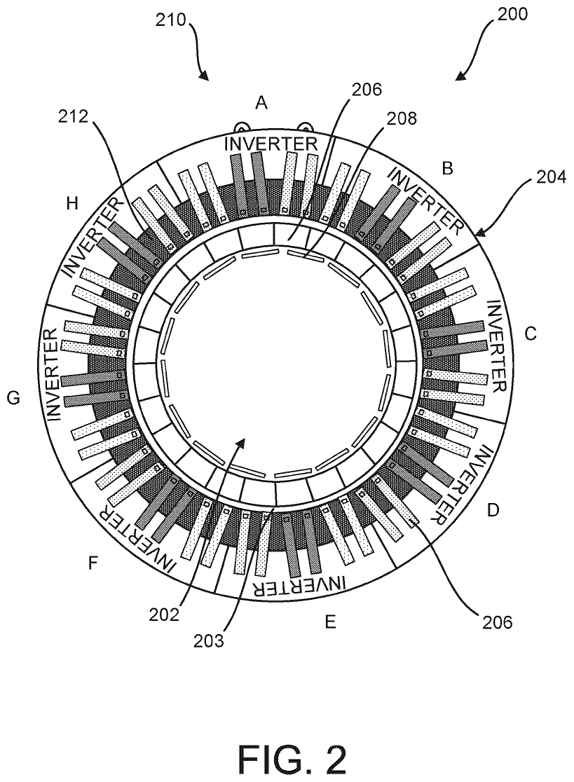

FIG. 1 shows an example of a system 100 for operating and controlling an electric machine 200 such as an electric motor or generator. The system 100 includes a plurality of controllers 102 (labeled as controllers 102A, 102B, 102C, . . . , and 102X for a total of X controllers), where each controller 102 separately and independently controls the operation of a corresponding inverter component 210 (where there are a total of X separately and individually operable inverter components 210), as further shown and discussed herein with respect to FIG. 2. Each of the controllers 102 may include a processor 104 and memory 106. The electric machine 200 is coupled with one or more sensors 110 which may detect one or more condition(s) of the components forming the electric machine 200. The condition(s) may be any suitable condition including but not limited to temperature or the length/period of time in which certain components have been in operation (either in total, or in continuous operation without stopping), temperatures of the inverters, fault conditions of the inverters, physical locations of the inverters (e.g., a position of each inverter component 210 with respect to a stator 204 as shown in FIG. 2), or health of the inverters, etc., as further disclosed herein. The controllers 102 and the sensor(s) 110 may be operatively (that is, physically and/or electrically) coupled with a master controller 112 which includes a master processor 114 and master memory 116. The master controller 112 may be configured to send operation instructions for the inverter components 210 to each of the controllers 102 electrically coupled therewith, in a configuration where the controllers 112 and 102 are in master/slave configuration. In some examples, the sensor(s) 110 may be operatively coupled with each of the controllers 102 instead of the master controller 112, such that the slave controllers 102 may be able to determine and control the operation of the inverter components 210, while the master controller 112 may be configured to passively record the operation of the controllers 102, for example to transmit such information or data to a user device to inform the user as to the status of the electric machine's operation.

The processor 104, 114 may be a single-or multi-chip processor, a digital signal processor (DSP), an application specific integrated circuit (ASIC), a field programmable gate array (FPGA) or other programmable logic device, discrete gate or transistor logic, discrete hardware components, or any combination thereof, and the like. In this regard, a processor may be a microprocessor, or, any conventional processor, or state machine. A processor also may be implemented as a combination of computer devices, such as a combination of a DSP and a microprocessor, a plurality of microprocessors, one or more microprocessors in conjunction with a DSP core, or any other such configuration. The processors may be structured to perform or otherwise execute certain operations independent of the other processors. In other examples, two or more processors may be coupled via a bus to enable independent, parallel, pipelined, or multi-threaded instruction execution. All such variations are intended to fall within the scope of the present disclosure. In some examples, the processor 104 may be implemented physically on the corresponding inverter component 210 as a printed circuit board (PCB) to be installed as part of the stator 204, as further explained herein.

The memory device 106, 116 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 106, 116 may be one or more non-transitory computer-readable media. The memory device 106, 116 may be coupled to the processor 104, 114 (respectively) to store and provide computer code or instructions to the processor 104, 114 for executing at least some of the processes described herein. Moreover, the memory device 106, 116 may be or include tangible, non-transient volatile memory or non-volatile memory. Accordingly, the memory device 106, 116 may include database components, object code components, script components, or any other type of information structure for supporting the various activities and information structures described herein.

The memory 106 and 116 may be a memory device operable as machine or computer-readable media which store instructions that are executable by a processor, such as processor 104 or 114. As described herein and amongst other uses, the machine-readable media facilitates performance of certain operations to enable control of the electric machine 200. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming language, such as the “C” programming language or similar programming languages. The computer readable program code may be executed on one processor or multiple remote processors. In the latter scenario, the remote processors may be connected to each other through any type of network (e.g., CAN bus, etc.).

FIG. 2 is a cross-sectional view of an example of the electric machine 200 according to embodiments disclosed herein. The electric machine 200 includes a rotor 202 inside a stator 204, with an airgap 203 between the two. The rotor 202 includes a rotor core with rotor windings 206 and permanent magnets 208. The stator 204 includes an annular stator core with a plurality of teeth projecting radially inwards to define slots that accommodate stator windings 214. The stator windings 214 are in the form of coils located on the teeth and may be wound onto the teeth in situ, or else pre-formed coils may be slid onto the teeth. The stator 204 also includes a plurality of inverter components 210. The stator windings 214 may be a plurality of sets of windings, with each winding being coupled with one of the plurality of inverter components 210. Each inverter component 210, as explained above, may be operatively coupled with one of the controllers 102 as well as the sensor(s) 110, and the inverter components 210 may be operated separately and independently from each other. In the example shown, there are a total of eight (8) inverter components 210 (labeled “A” through “H”). However, it will be appreciated that any appropriate number of inverter components 210 may be provided. In some examples, the inverter components 210 may be formed as modular or segmented components which may be installed separately.

In operation, the rotor 202 rotates inside the stator 204 about a central axis of rotation. A magnetic flux developed by the permanent magnets 208 crosses the airgap 203 and combines with stator windings 214. In the case of motor operation, a varying electrical current is supplied to the stator windings 214 and the thus generated magnetic field causes the rotor 202 to rotate. In the case of generator operation, the rotor 202 is rotated by a prime mover (not shown) and the rotating magnetic field developed by the permanent magnets 208 causes an electrical current to flow in the stator windings 214. The stator windings 214 in the example shown are defined by the separate inverter components 210, where each inverter component 210 is a three-phase inverter. It is to be understood that although three-phase inverter is referred to herein, the inverter components 210 may alternatively include inverters of different phases such as six-phase inverters, for example.

In some examples, the stator 204 also includes a cooling loop 212 disposed within the housing or framework of the stator 204, to operate as a cooling mechanism for the inverter components 210. The cooling loop 212 may be formed as a channel through which a liquid such as coolant or antifreeze flows or is present so as to better control the temperature of each inverter component 210. The cooling loop 212 may be implemented to reduce or minimize the amount of thermal transfer from the stator 204 to the processors 104, which may be implemented as heat-sensitive PCBs installed physically on the inverter components 210, for example. In some examples, the cooling loop 212 may be made of any suitable material with low thermal conductivity, including but not limited to cement or ceramic with thermal conductivity less than about 20 Wm⁻¹K⁻¹, less than about 10 Wm⁻¹K⁻¹, less than about 5 Wm⁻¹K⁻¹, less than about 3 Wm⁻¹K⁻¹, or any other value therebetween. In some examples, the cooling loop 212 may include a cooling pipe fluidly coupled with the channel inside for flowing coolant therethrough.

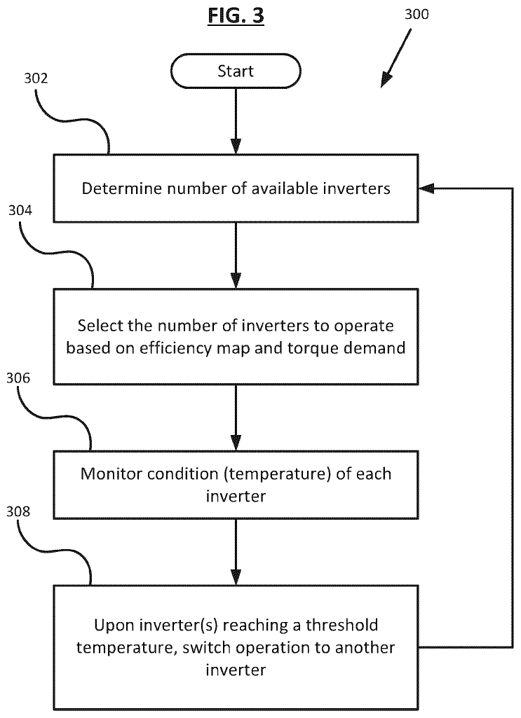

FIGS. 3 through 9 show different methods and processes or algorithms to be implemented by the controllers 102 and 112, or the processors 104, 114 thereof, to control the operation of the electric machine 200 including the individual inverter components 210 as explained above. FIG. 3 shows a process 300 in which, in step 302, the controller determines the number of available inverters or inverter components in the electric machine 200 that may be used for operation. The number of available inverter components may be any number equal to or less than the total number of the individual inverter components 210 as installed on the electric machine 200, which may be eight (8) in the example shown in FIG. 2. In step 304, the controller selects a subset number of inverters or inverter components to operate based on an efficiency map and a torque demand for the electric machine 200. For example, the number of inverter components that is selected may be an even number that is equal to or less than the number of available inverter components.

The controller proceeds to monitor one or more conditions such that, based on the monitored condition(s), the controller switches operation of at least one of the selected inverters with at least one of the available inverters that were not previously selected. For example, such condition(s) may include, but are not limited to, one or more of: temperatures of the plurality of independently operable inverters, fault conditions of the plurality of independently operable inverters, physical locations of the plurality of independently operable inverters, or health of the plurality of independently operable inverters. As disclosed herein, health of the inverters may refer to a number of “uses” and/or time of usage of the inverters (such as for each inverter pair) which may be tracked and/or maintained, for example. In some examples, the health of the inverters may refer to a predicted number of times the inverters may be used and/or a predicted length during which the inverters may remain in operation before the inverters' performance drops below an acceptable threshold, before the inverters become faulty, or before the inverters have an increased risk of becoming faulty if the inverters are kept in operation. In step 306, the controller monitors, using the sensor(s) 110, one or more of the aforementioned condition(s) such as a temperature of each of the available inverter components during operation of the selected number of inverter components in step 304. The available inverter components in this case include both the available inverter components that are selected to be in operation and the available inverter components that are not selected and thus are not in operation. In step 308, the controller switches operation to another inverter upon detecting that one or more of the operating inverters or inverter components have reached a threshold temperature. The threshold temperature may be an upper threshold temperature, a lower threshold temperature, or both. In some examples, the switching of the operation may be performed by swapping (e.g., if a first inverter is in operation and a second inverter is not in operation, the second inverter is then put in operation while the first inverter is taken off operation) or rotating (e.g., the operation of each inverter is subsequently transferred to a neighboring inverter in the same direction, such as in a clockwise or counterclockwise direction in a “round-robin” fashion with respect to the arrangement of the inverters or inverter components on the stator 204). In some examples, such swapping or rotating may assist in the management of the load applied on the inverters over time, in order to avoid a particular inverter pair having more load applied thereon or getting more use than other inverter pairs. That is, as an illustrative example, if the inverter pairs A/E and C/G were both appropriate for a given request but the pair A/E has considerably more use time than the pair C/G, it may be preferable to select the pair C/G to ensure a more even wear in the inverters or a more even use of the inverters. While these inverters may all be “healthy” or functional during operation of the electric machine, in some examples, it may be beneficial to take into consideration or “even out” the load management of the inverters over time. Subsequently, the process 300 returns to step 302 to determine again the number of available inverter components at that time, such that when the number of available inverter components changes, a new process 300 of inverter selection (step 304), temperature monitoring (step 306), and operation switching (step 308) may be performed accordingly.

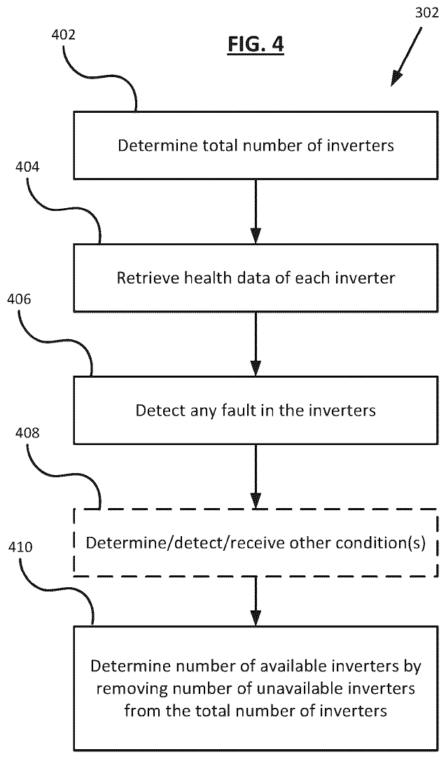

FIG. 4 shows an example of determining the number of available inverter components in step 302 of FIG. 3, according to embodiments disclosed herein. In step 402, the controller determines the total number of inverter components, which may be the total number of inverter components 210 as installed on the electric machine 200, for example as shown in FIG. 2, in which case the total number would be eight (8). In step 404, the controller retrieves health data of each inverter component 210. The health data is any type of data or information indicative of the possible state of health the inverter components 210 may be in, and such data or information may include, but is not limited to, the number of times that each inverter or pair of inverter components has been used (e.g., total usage count), the length of time that each inverter or pair of inverter components has been used (e.g., total usage time), detected temperature for each inverter or pair of inverter components, etc. Such data or information may be tracked and recorded/stored in memory 106, 116 to be accessible. In some examples, when only a single inverter pair is needed (N=2), the inverter pair with the least usage time or usage count may be selected, instead of basing the selection on the inverter temperature. In some examples, the health of the entire electric machine may be managed over time, by taking action to ensure that a particular inverter pair or group is not always used with greater frequency or timespan over another equivalent inverter pair or group over a period of time, as further disclosed herein. It should be understood that the health of an inverter may not necessarily be correlated with the number of times that the inverter is used or the length of time for which the inverter is used.

That is, in some cases, a newer inverter may experience failure or become faulty quicker than an older inverter which may be operational for much longer than the newer inverter. As such, it should be understood that the health data may include a plurality of factors which may or may not contribute to the actual cause of failure for the inverter.

In step 406, the controller detects any fault or (or, alternatively, bad state-of-health) in any one or more of the inverter components 210. For example, such faults may be caused by defective wiring or the inverter being disconnected from the power source, or any condition which may cause the inverter components to not function as intended. In step 410, the controller determines the number of available inverter components by removing the number of unavailable inverter components from the total number of inverter components. The steps 404 and 406 facilitate in determining which of the total number of inverter components is/are unavailable. In some examples, step 408 may be additionally or optionally implemented, in which the controller may determine, detect, or receive any other condition or conditions which may indicate that certain inverter or inverter components may be unavailable. For example, such conditions may include user input or other inverter-specific settings (e.g., inverter-specific operation conditions that may affect when such inverters may be operated).

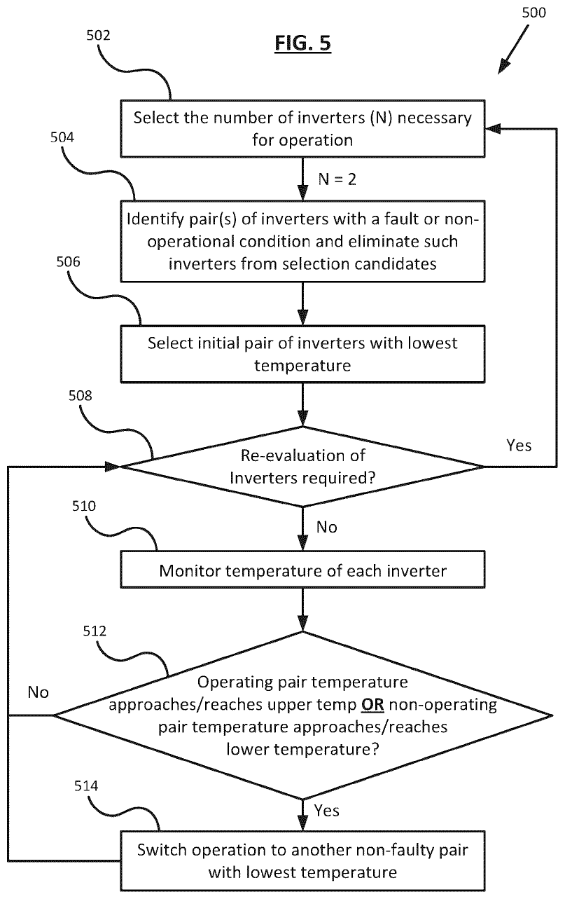

FIGS. 5, 6, 8, and 9 show processes 500, 600, 800, and 900, respectively, that are implemented in accordance with the different numbers of inverters that may be deemed necessary for operating the electric machine 200 according to FIG. 2, where the total number (X) of inverter components 210 is eight (8). It should be understood that, although these examples only implement up to 8 inverters, other examples may include a different number of inverters, for example, X=10, 12, 14, 16, 18, etc., but still use similar processes and steps such that the processes are adjusted accordingly to suit the number of inverters involved.

The process 500 of FIG. 5 begins with step 502, in which the controller selects the number of inverters (N) necessary for operation such that N=2. The N inverters are a subset of the total of X inverters. That is, the controller may receive input, such as from the user or instructions indicating a power demand for the electric machine 200, and in response to such input, determine or calculate how many inverters need to be operated to meet the demand. In some examples, if the electric machine 200 is implemented in an electric or hybrid vehicle as vehicle motor/generator, the input may come from a mapping software based on the potential routes of the vehicle, or determined using predicted power demand based on surrounding environments such as road conditions or weather conditions. Additionally or alternatively, any other suitable inputs may be implemented to assist in the controller determine the power demand for the electric machine. As such, the controller selecting N=2 may indicate that the power demand is relatively low, such as when the vehicle may be traveling on a smooth road without any incline, thereby having a smaller torque demand, for example.

In step 504, the controller identifies one or more pairs of inverters or inverter components having a fault or non-operable condition, and eliminates such inverters from being included in the selection candidates, thus preventing such faulty inverters from being subsequently selected. In some examples, the non-operable condition may include or may be determined based on user preference and/or health data as explained above. In some examples, each of the pairs of inverters may be arranged and chosen in a predetermined manner, for example a pair of inverters including two inverters or inverter components located on opposing sides of the electric machine so as to be in a 180-degree separation with respect to each other.

As an illustrative example, with respect to the inverter components 210 in FIG. 2, the 180-degree separation pairing may result in forming the following pairs: A/E, B/F, C/G, and D/H. However, in some cases, there may be benefit in pairing up inverters that are not separated by 180 degrees, for example when there are not enough inverters that are available for operation. By forming inverter pairs that are not separated by 180 degrees, for example with one of the inventors being offset by one slot, the electric motor may be kept in operation with whichever inverters are currently available, instead of having to stop the operation entirely.

In step 506, the controller selects an initial pair of inverters with the lowest temperature to operate. For example, such selection may be made in response to the sensor(s) 110 measuring the inverter temperatures at or during any one of steps 502 or 504. Alternatively, the inverter temperatures may be stored in the memory 106, 116 to be accessed at the time of making such selection.

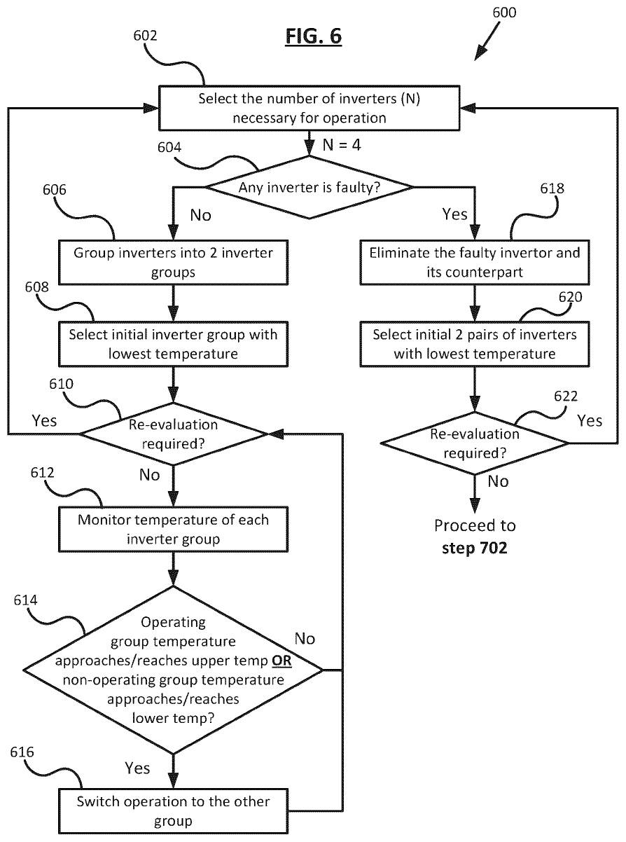

In step 508, the controller determines whether re-evaluation of the inverter components is necessary. For example, the controller may detect a certain change in operating conditions which may be indicative of a need to re-evaluate the number of inverters. In some examples, this may be due to the vehicle moving uphill such that the torque demand is greater. In some examples, this may be due to an increase in power demand, making it difficult or impossible for just two operating inverters to meet the demand. If it is determined that the number of operating inverters needs to be changed (“Yes”) which in this case is to be increased from N=2, the process 500 proceeds to step 502, where the controller may change the number N to any other suitable number, shown in FIGS. 6, 8, and 9 as further explained herein.

Otherwise, if there is no need to change the number of operating inverters (“No”), the controller proceeds to step 510 in which the controller monitors the temperature of each inverter that is available for operation. This includes monitoring both the inverters that are selected in step 506 and the inverters that are available (i.e., not having any fault or condition to prevent the inverter from operating normally) but not selected to operate in step 506. In step 512, the controller determines either: (a) whether the temperature of the operating pair of inverters is approaching or reaching an upper temperature threshold, or (b) whether the temperature of any of the non-operating pairs of inverters is approaching or reaching a lower temperature threshold. That is, step 512 determines whether the inverter pair that is in operation is getting too hot or the inverter pairs that are not in operation are getting too cold.

If in step 512 the controller determines that neither condition (a) nor (b) is fulfilled (“No”), the process 500 returns to step 508. However, if the controller determines that either one of the conditions (a) or (b) is met (“Yes”), as per step 514, the controller switches operation of the inverters from the current pair to another non-faulty pair (that is, available pair) with the lowest temperature among all the available pairs. Subsequently, the process 500 returns to step 508 to detect the presence or absence of the certain change in operating conditions as explained above.

The range of temperatures that the inverter or inverter component experiences is referred to as a delta temperature (ΔT) where a lower end of the range is referred to as a lower threshold temperature, and a higher end of the range is referred to as a higher threshold temperature. Ideally, an inverter operates within a predetermined delta temperature (which may be set by the manufacturer of the inverter or determined based on the inverter operation, for example), and the range of the delta temperature may be kept as small as possible, in order to lengthen or prolong the operational life of the inverter. That is, if the inverter experiences extreme temperatures, whether it is high or low temperature, there is an increased risk of the inverters eventually malfunctioning or causing power losses, thereby reducing the efficiency of the electric machine. Therefore, it may be beneficial for the inverters to avoid reaching such extreme temperatures whenever possible.

In some examples, the threshold temperatures may be fixed. In some examples, the threshold temperatures may be determined dynamically during the operation of the inverters and set in a manner so as to (1) minimize the overall temperature delta, (2) maintain a predetermined average temperature, and/or (3) minimize the temperature of a particular inverter or inverter pair. In some examples, the threshold temperatures may be determined dynamically during operation so as to additionally or alternatively minimize the temperature range experienced by the coolant. In some examples, the threshold temperatures may be unique or specific to the particular inverter, such that each inverter, inverter pair, and/or inverter group may have its own unique thresholds as predetermined (for example by the manufacturer or the user) or as determined flexibly or dynamically during operation as explained above. In some examples, when the inverters have their unique threshold temperatures, such unique threshold temperatures may be considered when selecting which inverter pair to operate and/or which inverter pair to switch to next.

In some examples, the threshold temperatures that are used for these processes may vary, such that separate thresholds may be used during different stages of operation. For example, one set of thresholds (first set) may be used during a warmup phase of the system, and another different set of thresholds (second set) may be used during a post-warmup operation phase of the system. The first set may be determined based on the temperatures of the multiple inverters, the temperature of the circulating coolant, and/or time of operation for the system. In some examples, during the warmup phase, the upper threshold temperatures may be adjusted to be lower than the upper threshold temperatures during the normal operation phase, in order to provide all inverters with the opportunity to cycle on to warmup. In some examples, the lower and upper threshold temperatures may gradually increase in tandem during the transition from the warmup phase (first set) to the normal operation phase (second set). In some examples, the threshold temperatures may also change based on the inverter's age, the inverter's state of health, presence of any fault in the inverter, presence of any fault in the cooling system, etc. In some examples, the lower threshold temperature may range from about −20° C. to about 0° C., about 0° C. to about 20° C., from about 20° C. to about 40° C., or any other suitable value or range therebetween. In some examples, the upper threshold temperature may range from about 40° C. to about 60° C., from about 60° C. to about 80° C., from about 80° C. to about 100° C., or any other suitable value or range there between.

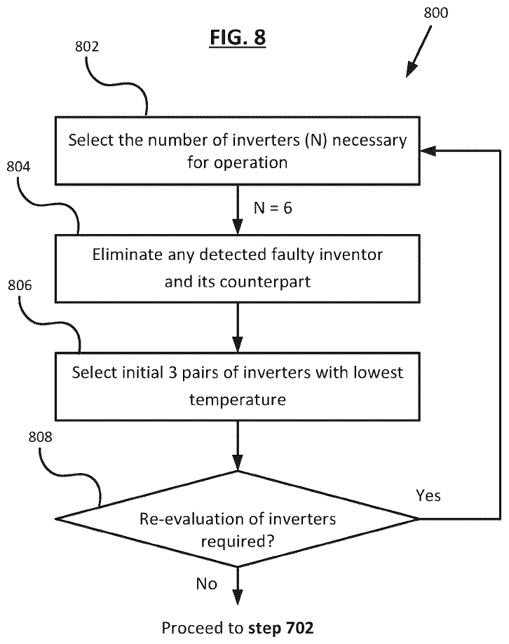

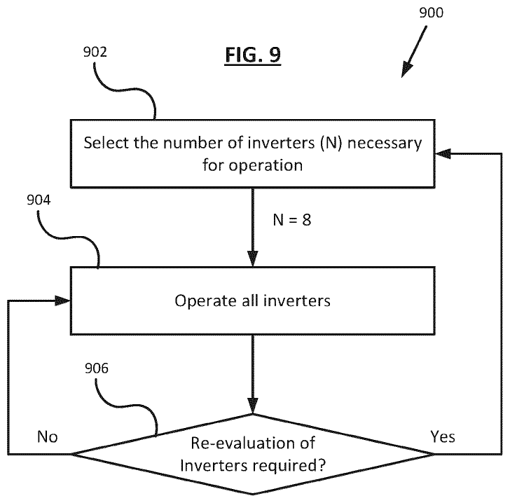

The process 600 of FIG. 6 begins with step 602, in which the controller selects the number of inverters (N) necessary for operation such that N=4. For example, this step 602 may follow step 508 in FIG. 5 in response to the controller determining that more inverters are needed than N=2 or, as further explained herein with respect to FIGS. 8 and 9, may follow the process 800 or 900 in response to the controller determining that a fewer number of operating inverters is to be used than N=6 or N=8.

In step 604, upon determining that N=4, the controller determines if any of the inverters is faulty. Here, the process 600 is based on the electric machine 200 having 8 total inverters or inverter components, but it is to be understood that, as explained above, any other suitable number of inverters may be incorporated. As such, hereafter, any number that is mentioned may be adjusted or changed accordingly to accommodate other electric machines having a different number of total inverters implemented therein.

If there is no fault detected in any of the inverters (“No”), in step 606, the controller groups or separates the inverters into two (2) inverter groups. When the total number of inverters is 8, each group would have 4 inverters therein. In some examples, the groups are formed such that the inverters in each group are separated from each other as much as possible. For example, in the 8-inverter example of FIG. 2, the first group may include the inverter components 210 labeled as A/C/E/G, and the second group may include the inverter components 210 labeled as B/D/F/E, such that the inverter components 210 in each group have a 90-degree separation with respect to each other.

In step 608, the controller selects the initial inverter group with the lowest temperature to use as the operating inverter group for the electric machine. In some examples, the lowest temperature may refer to the lowest total temperature or the lowest average temperature as measured across all the inverters assigned to the particular group. In some examples, the lowest temperature may refer to the lowest temperature as measured in any one of the inverters assigned to the group.

During operation of the selected inverter group, in step 610, the controller determines whether re-evaluation of the inverter components is necessary. For example, the controller may detect a certain change in operating conditions which may be indicative of a need to re-evaluate the number of inverters. If “Yes” the process 600 returns to step 602 to select a different number for N, whether it is to decrease to N=2 or increase to N=6 or N=8. If “No” the process 600 proceeds to step 612 in which the controller monitors the temperature of each inverter group. In some examples, the temperature may be monitored for the inverter group as a whole, such that a total or average temperature is calculated and monitored. In some examples, the temperature may be monitored for the individual inverters.

In step 614, the controller determines either: (a) whether the temperature of the operating inverter group is approaching or reaching an upper temperature threshold, or (b) whether the temperature of the non-operating inverter group is approaching or reaching a lower threshold temperature. If in step 614 the controller determines that neither condition (a) nor (b) is fulfilled (“No”), the process 600 returns to step 610. However, if the controller determines that either one of the conditions (a) or (b) is met (“Yes”), as per step 616, the controller switches operation of the inverters from the current inverter group to the other inverter group that was not in operation. Subsequently, the process 600 returns to step 610 to detect the presence or absence of the certain change in operating conditions as explained above.

Alternatively, if in step 604 the controller determines that there are faulty inverters (“Yes”), in step 618 the controller eliminates the faulty inverter and its corresponding counterpart in a pair. For example, an inverter's counterpart may be the inverter that is at the 180-degree separation with respect to it, that is, located in an opposing section of the electric machine 200 as explained above. As such, when one inverter or inverter component is detected to be faulty, not only is the faulty inverter eliminated from the selection, but so is its corresponding counterpart. As a result, this step results in one or more inverter pairs to be eliminated from the selection, where each of the eliminated inverter pairs includes at least one faulty inverter.

In step 620, the controller selects the initial two (2) pairs of inverters to operate based on which of the inverters has the lowest temperature. Similar to step 608, the lowest temperature may refer to the lowest total temperature or the lowest average temperature as measured in the pair of inverters, or the lowest temperature as measured in either one of the two inverters in each pair. In step 622, the controller determines whether re-evaluation of the inverter components is necessary. For example, the controller may detect a certain change in operating conditions which may be indicative of a need to re-evaluate the number of inverters. If “Yes” the process 600 returns to step 602, and if “No” the process 600 proceeds to step 702 of process 700.

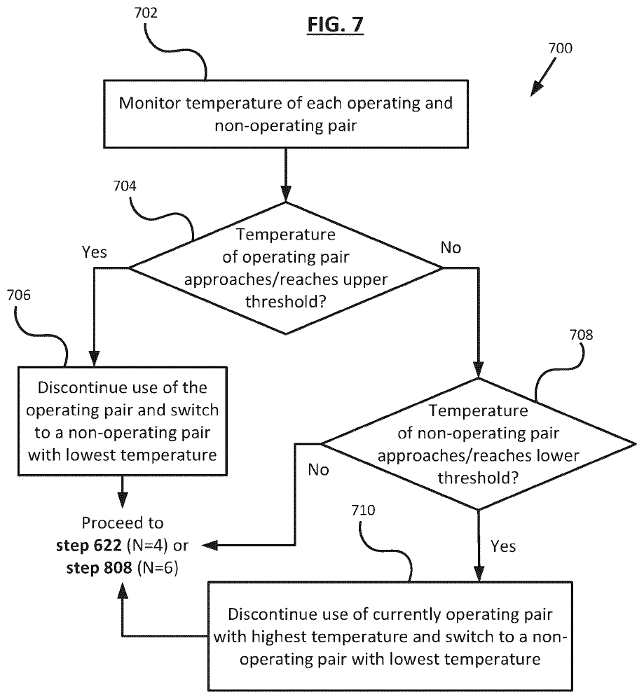

FIG. 7 shows a process 700 which may be implemented in both process 600 and process 800, as further explained herein. The process 700 begins with step 702 in which the controller monitors the temperature of each of the available inverter pairs, that is, the operating inverter pairs as well as the non-operating inverter pairs, but not the faulty inverter pairs which were eliminated from the selection. In step 704, the controller determines if the temperature of any currently operating inverter pair (among the multiple inverter pairs currently operating) is approaching or reaching an upper temperature threshold. If “Yes”, the controller in step 706 discontinues the use of the operating inverter pair whose temperature is approaching or reaching the upper temperature threshold, and switches operation to a non-operating inverter pair with the lowest temperature. Thereafter, the controller proceeds to perform step 622, if N=4, or to perform step 808, if N=6.

Alternatively, if the result of step 704 is “No”, the controller in step 708 determines if the temperature of a non-operating inverter pair is approaching or reaching a lower temperature threshold. If “Yes”, the controller in step 710 discontinues the use of the currently operating inverter pair with the highest temperature (among the multiple inverter pairs currently operating), and switches operation to a non-operating inverter pair with the lowest temperature, which may be the non-operating inverter pair that is approaching or reaching the lower temperature threshold. If the result of step 708 is “No” or after step 710 is performed, the process 700 proceeds to either step 622 if N=4, or step 808 if N=6. In some examples, the steps 704 and 708 may be interchangeable in order or priority such that step 708 may precede step 704.

FIG. 8 shows a process 800 which begins with step 802, in which the controller selects the number of inverters (N) necessary for operation such that N=6. For example, this step 802 may follow step 508 in FIG. 5 or step 610/622 in FIG. 6 in response to the controller determining that more inverters are needed than N=2 or 4, respectively, or, as further explained herein with respect to FIG. 9, follow the process 900 in response to the controller determining that a fewer number of operating inverters is to be used than N=8.

In step 804, similar to step 618, the controller eliminates the faulty inverter and its corresponding counterpart in a pair. For example, an inverter's counterpart may be the inverter that is at the 180-degree separation with respect to it, that is, located in an opposing section of the electric machine 200 as explained above. In step 806, the controller selects for operation the initial three (3) inverter pairs with the lowest temperatures.

In step 808, the controller determines whether re-evaluation of the inverter components is necessary. For example, the controller may detect a certain change in operating conditions which may be indicative of a need to re-evaluate the number of inverters. In some situations, because step 806 requires 3 inverter pairs to be operable, if more than one inverter pair is eliminated in step 804, there would be only 2 available inverter pairs, thereby being an indication that there is a need to re-evaluate the number (N) of the necessary inverters to reduce the value of N, since it is not possible to operate with 3 inverter pairs. If the result of step 808 is “Yes”, the process 800 returns to step 802, and if the result is “No”, the process 800 proceeds to step 702 of process 700 as explained above.

FIG. 9 shows a process 900 which begins with step 902, in which the controller selects the number of inverters (N) necessary for operation such that N=8 (or N=X). For example, this step 902 may follow step 508 in FIG. 5, step 610/622 in FIG. 6, or step 808 in FIG. 8 in response to the controller determining that more inverters are needed than N=2, 4, or 6, respectively. In step 904, the controller operates all the available inverters (that is, 8 inverters if the total number of inverters is 8), and in step 906, the controller determines whether re-evaluation of the inverter components is necessary. If the result of step 906 is “Yes”, the process 900 returns to step 902 to select a new value for N, and if the result of step 906 is “No”, the process 900 returns to step 904 for the controller to continue operating all inverters for maximum power output (e.g., for a maximum torque in an electric motor or a maximum electrical power generation in a generator).

As explained above, the electric motor 200 may include more than 8 total inverter components 210, such that X=10, 12, 14, 16, 18, etc. In such examples, additional processes may be included based on adjusting the process 800 to increase the number of pairs that are selected in step 806. For example, when X=12, two additional processes may be included to implement N=8 and N=10, such that for N=8, during the process, initial 4 inverter pairs with the lowest temperatures may be selected, and for N=10, during the process, initial 5 inverter pairs with the lowest temperatures may be selected. As for N=12, the process is similar to the process 900, because N=12 =X. Furthermore, when X=12, the controller may group or separate the inverters into three (3) inverter groups in step 606, such that there are 3 inverter groups with 4 inverters in each group, instead of 2 inverter groups with 6 inverters in each group. In the 3-group scenario, the inverter groups may alternate operation from one group to another in a “round-robin” selection, where the operating inverters are shifted clockwise or counterclockwise by one each time the inverter or inverters approach or reach the appropriate threshold temperatures.

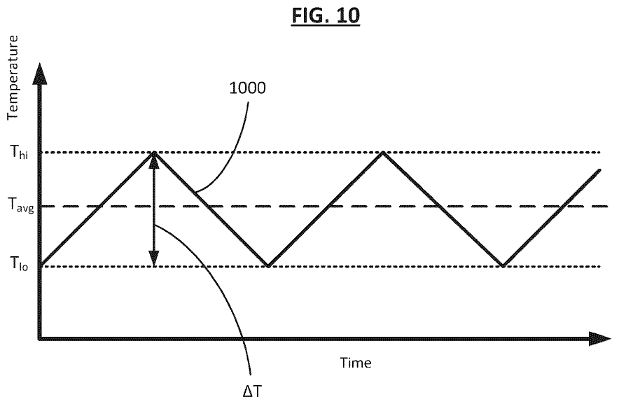

FIG. 10 shows an example of a change in temperature 1000 which may be experienced by one of the inverter components as disclosed herein. The temperature 1000 may change between a upper threshold (Tₕᵢ) and a lower threshold (Tₗₒ) such that the temperature 1000 may stay within a certain range from an average temperature (T_{avg}) which may be determined based on the individual inverters. A delta temperature (ΔT) may be defined as a temperature difference between a peak (maximum) of the temperature 1000 and a valley (minimum) of the temperature 1000 as the temperature of the inverter fluctuates during operation. In some examples, the inverter is allowed to cool down for a period of time after reaching the maximum temperature, which may be at the upper threshold, and then allowed to operate again when the inverter reaches the minimum temperature, which may be the lower threshold. As such, the average temperature may be thus controlled by adjusting the upper and lower thresholds at which the operation of the inverter may be halted or resumed accordingly. In some examples, the user may select the range of the delta temperature (ΔT) by for example raising the maximum temperature and lowering the minimum temperature. In some examples, the maximum temperature may be select based on the coolant and component temperature. In some examples, the maximum temperature may be also selected based on the load applied on the inverter component. When the load changes, the maximum temperature and/or the average temperature may be changed gradually over a period of time without changing the delta temperature (ΔT) by keeping some of the inverter components in operation for a longer period of time if the load is reducing, or by keeping some of the inverter components in operation for a shorter period of time if the load is increasing. In some examples, maintaining the assumed delta temperature (ΔT) may increase the component life of the inverter system by reducing the range of temperature in which the inverter components are allowed to operate. In some examples, the threshold temperatures may be defined as one-half of the delta temperature (ΔT) from the average temperature, e.g., T_{threshold}−T_{avg}±ΔT/2, such that Tₕᵢ=T_{avg}+ΔT/2 and Tₗₒ=T_{avg}−ΔT/2. As such, the threshold temperature (T_{threshold}) may be defined by a temperature range (ΔT) centering on a predetermined average temperature (T_{avg}). In some examples, the system may track the amount of time that the inverter components have operated with a delta temperature (ΔT) greater than a predetermined threshold value. In some examples, the system may track the amount of time that the inverter components have operated at a maximum ΔT value or an average ΔT value over time, as experienced by each inverter. The time tracked may thus be used to determine or predict a state of health of the inverter components.

Potential advantages or benefits of implementing the processes for controlling independently operable inverter components as disclosed herein may include, but are not limited to, minimizing the delta temperature (ΔT) for the inverter components so as to reduce the overall temperature of the system as well as to mechanically balance the system, for example by operating inverter pairs that are separated from each other by 180 degrees or any other suitable angle to evenly or symmetrically disperse the inverters in a group, as explained above.

Furthermore, reducing temperature of the individual inverters as well as of the electric machine as a whole may reduce the loss in power that is generated by the electric machine. In some examples, the aforementioned processes may lengthen the operational lifespan of the inverter components and the electric machine.

Although the examples and embodiments have been described in detail with reference to certain preferred embodiments, variations and modifications exist within the spirit and scope of the disclosure as described and defined in the following claims.

1.-15. (canceled)

16. A method of operating an electric machine using a controller, the method comprising:
receiving a torque demand for the electric machine, the electric machine comprising a plurality of independently operable inverters;
determining available inverters from the plurality of independently operable inverters;
selecting, from the available inverters, a subset number of the available inverters to operate based on an efficiency map of the electric machine and the torque demand for the electric machine; and
based on one or more conditions, switching operation of at least one inverter of the subset number of the available inverters with at least one inverter of the available inverters that is not in the subset number of the available inverters.

17. The method of claim 16, wherein the one or more conditions include one or more of: a temperature of the plurality of independently operable inverters, a fault condition of the plurality of independently operable inverters, a physical location of the plurality of independently operable inverters, or a health parameter of the plurality of independently operable inverters.

18. The method of claim 16, further comprising:
monitoring a temperature of the available inverters during operation; and
responsive to detecting that a temperature of at least one inverter of the subset number of the available inverters or a temperature of at least one inverter of the available inverters that is not in the subset number of the available inverters is reaching or approaching a threshold temperature, switching the operation of the at least one inverter of the subset number of the available inverters with the at least one inverter of the available inverters that is not in the subset number of the available inverters.

19. The method of claim 18, wherein the threshold temperature is defined by a temperature range (ΔT) centered on a predetermined average temperature.

20. The method of claim 16, further comprising:
determining health data of the plurality of independently operable inverters;
detecting at least one fault in at least one of the plurality of independently operable inverters; and
removing, based on the health data and the at least one fault, unavailable inverters from being selected.

21. The method of claim 16, further comprising:
recording, by a memory unit of the controller, a number of times or a length of time that each inverter of the plurality of independently operable inverters is used; and
determining health data based on the number of times or the length of time that each inverter of the plurality of independently operable inverters is used,
wherein the health data is one of the one or more conditions.

22. The method of claim 16, further comprising:
monitoring a temperature of the available inverters prior to the selecting; and
selecting, from the available inverters, the subset number of inverters to operate based on the temperature that is monitored, wherein the subset number of inverters has a lowest temperature among the available inverters.

23. The method of claim 18, wherein the threshold temperature is an upper threshold temperature or a lower threshold temperature, and the switching of the operation comprises:
detecting either (a) the temperature of at least one inverter of the subset number of inverters is reaching or approaching the upper threshold temperature, or (b) the temperature of at least one inverter of the available inverters that is not in the subset number of inverters is reaching or approaching the lower threshold temperature; and
responsive to detecting either (a) or (b), switching the operation of the at least one inverter of the subset number of inverters with the at least one inverter of the available inverters that is not in the subset number of the available inverters.

24. The method of claim 16, wherein the subset number of inverters includes an even number of inverters, and the selecting comprises:
grouping the available inverters into a plurality of available inverter groups, wherein each available inverter group includes at least two available inverters; and
selecting at least one of the available inverter groups having a lowest temperature among the available inverter groups to operate.

25. The method of claim 16, further comprising:
detecting a change in operating conditions of the electric machine indicative of a requirement to re-evaluate the subset number of inverters to be selected; and
selecting, from the available inverters, a new subset number of inverters to operate based on the change in operating conditions of the electric machine.

26. A method of operating an electric machine using a controller, the method comprising:
receiving a torque demand for the electric machine, the electric machine comprising a plurality of independently operable inverters;
determining available inverters from the plurality of independently operable inverters;
selecting one or more inverter pairs of the available inverters to operate, wherein each inverter pair includes two of the available inverters coupled to machine winding sets positioned in 180 degrees of separation from each other in the electric machine; and
switching operation of at least one of the selected inverter pairs with at least one other inverter pair of the available inverters, wherein the at least one other inverter pair is not among the selected inverter pairs of the available inverters.

27. The method of claim 26, further comprising:
performing a fault check of the selected inverter pairs of the available inverters to operate;
determining, based on the fault check, that the at least one of the selected inverter pairs is faulty; and
switching the operation of the at least one of the selected inverter pairs that is determined to be faulty with the at least one other inverter pair of the available inverters that is not among the selected inverter pairs of the available inverters.

28. The method of claim 26, further comprising:
determining, based on balancing an amount of coolant in the electric machine, at least one other inverter pair of the available inverters for switching operation; and
switching the operation of the at least one of the selected inverter pairs with the at least one other inverter pair as determined.

29. A non-transitory computer-readable medium storing instructions that, when executed by a processor of a controller, cause the processor to:
receive a torque demand for an electric machine, the electric machine comprising a plurality of independently operable inverters;
determine available inverters from the plurality of independently operable inverters;
select, from the available inverters, at least one of (i) a subset number of the available inverters to operate, and (ii) one or more inverter pairs of the available inverters to operate, each inverter pair including two of the available inverters coupled to machine winding sets positioned in 180 degrees of separation from each other in the electric machine; and
based on one or more conditions, switch operation of at least one of (i) the subset number of the available inverters and (ii) the one or more inverter pairs of the available inverters with at least one of the available inverters that is not in the subset number of the available inverters or the one or more inverter pairs of the available inverters.

30. The non-transitory computer-readable medium of claim 29, wherein the instructions further cause the processor to:
monitor a temperature of the available inverters prior to selecting the at least one of the subset number of inverters and the one or more inverter pairs; and
select, from the available inverters, the at least one of the subset number of inverters and the one or more inverter pairs to operate based on the temperature that is monitored, wherein the at least one of the subset number of inverters and the one or more inverter pairs has a lowest temperature among the available inverters.

31. The non-transitory computer-readable medium of claim 29, wherein the instructions further cause the processor to:
detect either (a) a temperature of at least one inverter of the subset number of inverters is reaching or approaching an upper threshold temperature, or (b) a temperature of at least one inverter of the available inverters that is not in the subset number of inverters is reaching or approaching a lower threshold temperature; and
responsive to detecting either (a) or (b), switch operation of the at least one inverter of the subset number of inverters with the at least one inverter of the available inverters that is not in the subset number of inverters.

32. The non-transitory computer-readable medium of claim 29, wherein the instructions further cause the processor to:
determine, based on balancing an amount of coolant in the electric machine, at least one other inverter pair of the available inverters for switching operation; and
switch operation of at least one selected inverter pair with the at least one other inverter pair as determined.

33. An electric machine system comprising the non-transitory computer-readable medium of claim 29.

34. A power system comprising the electric machine system of claim 23, wherein the electric machine is configured to operate as a motor/generator, and wherein the master controller is further configured to receive an input signal indicative of a predicted power demand.

35. An electric vehicle or a hybrid vehicle comprising the power system of claim 24.
